(19) United States
(12) Patent Application Publication
(10) Pub. No.: US 2005/0188295 A1
(43) Pub. Date: Aug. 25, 2005

(54) Systems and methods for an extensible administration tool

(76) Inventors: Loren Konkus, Novi, MI (US); Chris Chiodo, Pelham, NJ (US); Patrick Calahan, San Francisco, CA (US)

Correspondence Address: FLIESLER MEYER, LLP, FOUR EMBARCADERO CENTER, SUITE 400, SAN FRANCISCO, CA, 94111, US

(21) Appl. No.: 10/786,761

(22) Filed: Feb. 25, 2004

(51) Int. Cl. H04Q 7/20

(52) U.S. Cl. 715/500

(57) ABSTRACT

A system and method for an extensible administration tool, comprising: a first graphical user interface (GUI) operable to provide hierarchical navigation of a tree; a second GUI operable to provide at least one control panel; a framework for customizing the first and second GUIs; and wherein the at least one control panel can be activated by selection of the node in the tree.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATIONS

This application is related to the following co-pending applications which are hereby incorporated by reference in their entirety:

SYSTEMS AND METHODS FOR PORTAL AND WEB SERVER ADMINISTRATION, U.S. Application No.______, Inventors: Christopher E. Bales, et al., filed on______. (Attorney's Docket No. BEAS-1371US1)

SYSTEMS AND METHODS FOR NAVIGATING A GRAPHICAL HIERARCHY, U.S. Application No.______, Inventors: Christopher E. Bales, et al., filed on______. (Attorney's Docket No. BEAS-1372US0)

SYSTEMS AND METHODS FOR CONTEXT-SENSITIVE EDITING, U.S. Application No.______, Inventors: Christopher E. Bales, et al., filed on______. (Attorney's Docket No. BEAS-1373US0)

SYSTEMS AND METHODS FOR PERSONALIZING A PORTAL, U.S. Application No.______, Inventors: Christopher E. Bales, et al., filed on______. (Attorney's Docket No. BEAS-1381US0)

### FIELD OF THE DISCLOSURE

The present disclosure relates generally to graphical system administration tools that are extensible by third parties.

### BACKGROUND

Conventional graphical tools for performing administration and management of network accessible resources can allow for the recognition an integration of new resources as they arise. However, conventional tools typically integrate new resources into a general-purpose graphical user interface. What is desired is an administration and management tool with a graphical user interface that can easily be custom tailored to each resource.

### BRIEF DESCRIPTION OF THE DRAWINGS

FIG. 1 is an illustration of an administration console in an embodiment.

FIG. 2 is an flow diagram for creating a console extension in an embodiment.

FIG. 3 is an exemplary Java class for implementing the NavTreeExtension interface in an embodiment.

FIG. 4 is an exemplary code fragment for extending a navigation tree in an embodiment.

FIG. 5 is an illustration of nested tabs in a graphical user interface.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In one embodiment, a user interface provides a means for a user to interact with one or more processes that are operable to configure and manage portals and/or web servers. By way of a non-limiting example, a user interface can include one or more of the following: 1) a graphical user interface (GUI); 2) an ability to respond to sounds and/or voice commands; 3) an ability to respond to input from a remote control device (e.g., a cellular telephone, a personal digital assistant, or other suitable remote control); 4) an ability to respond to gestures (e.g., facial and otherwise); 5) an ability to respond to commands from a process on the same or another computing device; and 6) an ability to respond to input from a computer mouse and/or keyboard. This disclosure is not limited to any particular user interface. Those of skill in the art will recognize that many other user interface embodiments are possible and fully within the scope and spirit of this disclosure.

This document describes how to extend an administration console (or “console”). By doing so, a user can create their own control panels that appear along with the standard console control panels. The administration console is a browser-based graphical user interface that can be used to manage a application/web servers. The Administration Console is extended by adding control panels and navigation elements that appear along with the supplied system screens. A console extension can provide functionality not included in a standard administration console or an alternate interface for existing functionality. For example, a console extension can:
Provide custom management of applications deployed on an application/web server.
Manage third-party systems.
Manage a custom security provider.
Provide customized monitoring and management screens for a server domain.

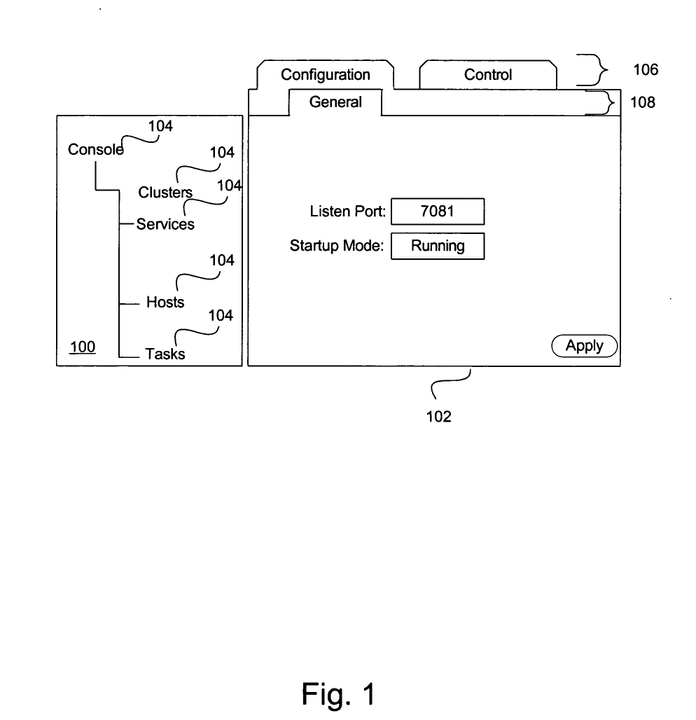

FIG. 1 is an illustration of an administration console in an embodiment. In one embodiment, an administration console extension can be implemented in the Java™ programming language, JavaServer Pages (JSP), HTML, and Java Mbeans. Mbeans are Java objects used for system administration. However, the present disclosure is not limited to any one programming language, operating system or hardware platform. Those of skill in the art will appreciate that other embodiments based on different programming languages, operating systems and hardware platforms are entirely within the scope and spirit of the present disclosure.

The administration console can include a navigation tree 100. In one embodiment, the navigation tree is a Java applet that allows users to navigate among the console control panels. The navigation tree can include one or more nodes 104. A node can contain other nodes or can call control panels that are displayed in the right pane of the console. A console extension can add one or more nodes to the navigation tree. Although two levels of tabbed dialogs (106 and 108) are illustrated, up to N-levels of tabbed dialogs are supported. Control panel 102 is displayed when a user selects one of the tabbed dialogs or tree nodes. Control panels are where the functionality of a console extension appears.

In one embodiment, To create a console extension, a user can create the following programmatic elements:
A web application and any additional Java classes or JSP tag libraries that a user require to implement a user extended console screen. A tag is a directive to perform a function/action.
A Java class that defines a new node in the navigation tree where a link to a control panel appears. A user can also use this class to initialize functionality required for the console extension. This class can implement an interface that is part of an API.
A JSP that defines the behavior of the new node in the navigation tree and (optionally) defines additional nodes that appear under a user new node. Menu options that appear when users right-select on the node can also be defined.
One or more JSPs that define control panel(s). A JSP tag library is supplied that allows a user to construct a tabbed interface. The option of utilizing an standard HTML style sheet that to create screens with a similar look and feel can be provided.
(Optional) Localization catalogs a user can use to look up localized strings for text and labels that appear in a user console extension. Localization catalogs are constructed using XML.

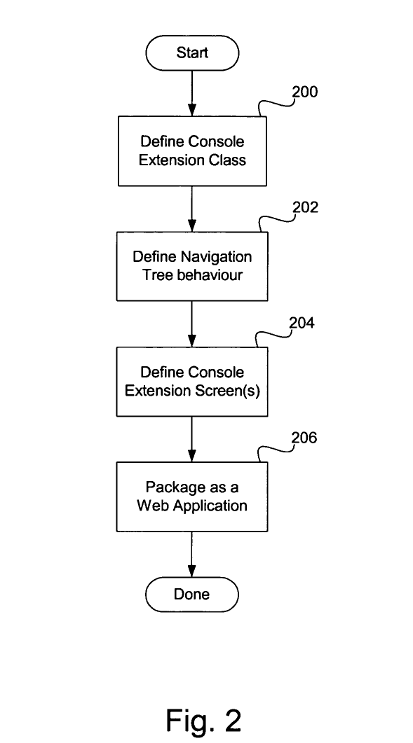

FIG. 2 is an flow diagram for creating a console extension in an embodiment. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.
Step 200 creates a Java class that defines a user Administration Console Extension. This class defines where a user console extension appears in the navigation tree and can provide additional functionality required by a user extension.
Step 202 defines the behavior of the Navigation tree. In this step a user can define multiple nodes that appear under the node a user define in step 1. A user can also define right-select menus and actions.
Step 204 writes JSP(s) to display control panel(s). A user may use localized text by looking up strings in a localization catalog. A supplied tag library allows a user to create tabbed dialog screens similar to those in the standard Administration Console and to access the localization catalogs.
Step 206 packages the JSPs, catalogs, and Java classes as a Web Application. The Web Application containing a user console extension can then be deployed on an administration server in a user server domain.

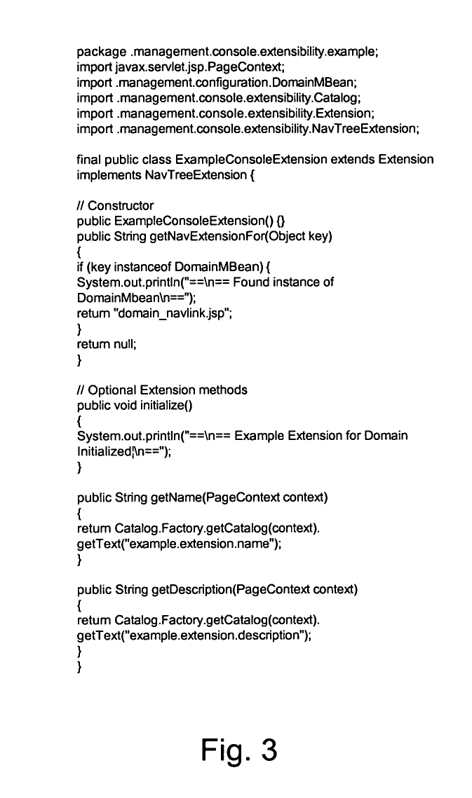

FIG. 3 is an exemplary Java class for implementing the NavTreeExtension interface in an embodiment. In one embodiment and by way of a non-limiting example, a user console extension can be written as a Java class that extends a common interface and implements a second class. By way of a non-limiting example, the following provides an illustration of how to create such a class:
Decide where (that is, under which node) in the navigation tree the console extension will appear. In one embodiment, each node in the console is associated with an MBean object. By associating a user extension with one of these MBean objects using the steps in this procedure, a user console extension can appear as a new node under one of these existing nodes. (MBeans are Java objects used for configuring a Server domain.) The choice of where to place the node(s) representing a user console extension can be determined by the functionality of a user console extension. For example, if a user console extension is related to server instances in a domain, place a user console extension node under a Servers node by associating a user extension with a ServerMBean. A user console extension will appear under each instance of a configured object that appears under a node. For instance, if the Servers node is selected in the navigation tree, a user extension will appear under each configured server in a user domain. If it is desired that the extension to appear at the top (domain) level of the navigation tree, associate a user extension with a DomainMBean.

Add an import statement for the MBean class associated with the user console extension. The navigation tree node where a user access a user console extension appears is a child of the node for this Mbean. For example:

import .management.configuration.DomainMBean.

Add an import statement:

import .management.console.extensibility.NavTreeExtension;

If required for the functionality of a user console extension, a user may want to add the following import statements:

import .management.console.extensibility.Catalog;
import .management.console.extensibility.Extension;
import javax.servlet.jsp.PageContext;

Declare the class name of this class. For example:
   final public class ExampleConsoleExtension extends Extension implements NavTreeExtension

Add a public constructor, without arguments. For example:

public ExampleConsoleExtension( ) { }

Define the getNavExtensionFor( ) method. When the Administration Console initializes itself, it calls this method, passing in the name of the associated MBean as the Object argument as it constructs each node of the navigation tree. In this method, test to see if the Object argument is an instance of the MBean associated with a node under which a user console extension should appear. If the Object is an instance of this MBean, the method should return a URL to a JSP page that defines the behavior of the node in the navigation tree, otherwise the method should return null. For example:

```
public String getNavExtensionFor(Object key)
{
    if (key instanceof DomainMBean) {
        System.out.println(
        “\nFound an instance of the
    DomainMbean\n”);
    return “domain_navlink.jsp”;
    }
    return null;
}
```

In the above example, when the system constructs a node for the DomainMBean it can invoke this method, passing in the name of a Domain as the Object argument. Because the Object is an instance of the DomainMBean, the method returns the URL domain_navlink.jsp. The System.out.println statements are optional and serve only to display the message to standard out.

In one embodiment, the getNavExtensionFor ( ) method can return a URL for each console extension node that appears in the navigation tree. This URL can point to a JSP that defines the behavior of this node. In this JSP, the following can be defined:
Additional sub-nodes that appear as children of a node.
An icon that can appear adjacent to a node's label.
A right-select menu. Items on the menu can call a URL that is displayed in the console. A user can also define separators (a horizontal line in the menu list) that display in the right-select menu.

In one embodiment and by way of a non-limiting example, to create a JSP that defines a navigation tree node:
Create a new JSP file whose name matches the URL returned from the getNavExtensionFor( ) method, for example domain_navlink.jsp.
Save the JSP file in the top-level directory of the Web Application containing a user console extension.

Add a taglib statement, e.g.:

<%@ taglib uri=‘console_extension_taglib.tld’ prefix=‘wl’ %>

(Optional) If a user need access to an object in this JSP, add the following JSP tag:

<wl:extensibility-key id=‘domainKey’ class=‘MyObjectClass’/>

Where MyObjectClass is the Java class name of the object a user want to access.

Add one or more <wl:node> tags. These tags describe nodes that appear in the navigation tree. A user can nest <wl:node> tags to create child nodes. The following attributes of the <wl:node> tag can be used to define the appearance and functionality of a node: url, label, labelId, icon, expanded, target, and font. The label attribute defines the displayed name of the tab. If a user want to localize this name a user can use the labelId attribute to look up the name in the localization catalog. The icon attribute points to an image file and displays the image as an icon for this node in the navigation tree. For example:

```
<wl:node
    label=‘<%=“My Console Extension”%>’
    icon=‘/images/folder.gif’
    expanded=‘true’>
    <wl:node
        label=‘Nested Tabs’
        icon=‘/images/bullet.gif’
        url=‘/dialog_domain_example.jsp’>
    </wl:node>
    <wl:node label=‘Localization Examples’
        icon=‘/images/bullet.gif’>
    </wl:node>
</wl:node>
```

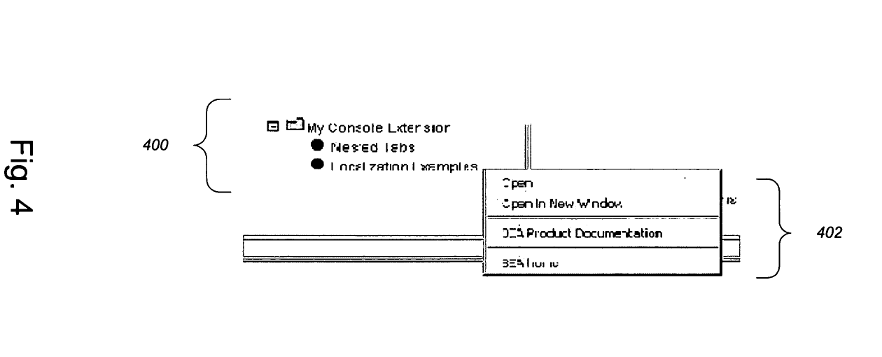

In one embodiment, the above code fragment will result in the navigation tree nodes 400 shown in FIG. 4.

Add one or more <wl:menu> tags to create right-select menu options. The following attributes can be defined for the <wl:menu> tag: label, labelId, url, and target. In one embodiment and by way of a non-limiting example, to add <wl:menu> tags to the “Localization Examples” node defined in the previous example in previous step, use the following code:

```
<wl:node
    label=‘Localization Examples’
    icon=‘/images/bullet.gif’>
    <wl:menu
        label=‘BEA Product Documentation’
        url=‘http://e-docs.bea.com/index.html’
        target=‘_blank’/>
    <wl:menu-separator/>1
    <wl:menu
        label=‘BEA home’
        Main Steps to Create an Administration
        Console Extension
        Extending the Administration Console 1-11
        url=‘http://www.bea.com’
        target=‘_blank’/>
</wl:node>
```

In one embodiment, the above code creates the right-select menu 402 shown in FIG. 4.

In one embodiment, control panels for the console extension can appear in the right pane of the console when an extension's node in the navigation tree is selected. To create the control panels in one embodiment, a user write a JSP using a supplied JSP tag library. The JSP that is displayed is determined by the url attribute of the <wl:node> tags in the JSP. The dialog screens can also include one or more tabbed dialogs that can be defined with the <wl:tab> JSP tag. These tabs can also contain nested sub-tabs. Each tab has a text label that a user can specify explicitly or, a user can specify a label ID that a user can use to look up a localized version of the tab's label in a localization catalog. With in each tab (that is, within a pair of <wl:tab> . . . </wl:tab> tags) a user can use JSP and HTML coding to create the functionality of a control panel. Any text that appears in these can also be localized by looking up text from a localization catalog.

It will be apparent to those of skill in the art that there are a variety of well known programming techniques to create the user interface of a user extension. These techniques, although not discussed, are within the scope and spirit of the present disclosure. In one embodiment, and by way of a non-limiting example, the following procedure can create a basic JSP that displays a control panel for a console extension:
Create a new JSP file whose name matches the URL specified with the url attribute of the <wl:node> tag that calls this screen, for example, domain_dialog.jsp.
Save the JSP file in the top-level directory of the Web Application containing a user console extension.

Insert this taglib statement at the top of the JSP file:

<%@ taglib uri=‘console_extension_taglib.tld’ prefix=‘wl’ %>

Insert HTML and JSP blocks into the JSP file. The display of a user console extension is defined by HTML code and JSP code that is translated into HTML code, therefore wrap a user display code in the following set of HTML tags:

```
<html>
    <head>
        <wl:stylesheet/>
    </head>
    <body>
        <div class=’content’>
        <wl:dialog>
        (Insert <wl:tab> statements here.)
        </wl:dialog>
        </div>
    </body>
</html>
```

The <wl:stylesheet/> tag in the <head> . . . </head> block is optional. When included, this tag formats a user text so that it is consistent with standard Server Administration Console pages.
Add one or more <wl:tab> tags in the JSP file (place these tags between the <wl:dialog> . . . </wl:dialog> tags). These tags can be nested. Each <wl:tab> tag defines a tabbed control panel that appears in the right panel of the console. A user can define the following attributes for each <wl:tab> tag: name, label, and labelId. Each <wl:tab> tag requires a closing (</wl:tab>)

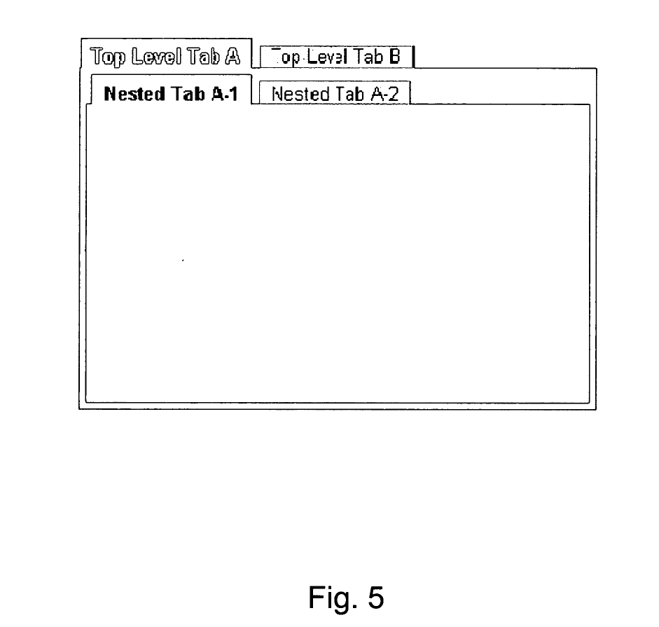

The HTML and JSP code that displays the body of a user console extension dialog screen can be included within a <wl:tab> block. A user can also localize the label displayed for the tab. In one embodiment and by way of a non-limiting example, the following code creates two top-level tabs, each containing two nested tabs (see FIG. 5):

```
<wl:tab name=‘TopLevelTabA’ label=‘Top Level Tab A’>
  <wl:tab name=‘NestedTabA1’ label=‘Nested Tab A-1’>
  (Insert a user JSP and/or HTML code
  for displaying a user console extension here.)
  </wl:tab>
  <wl:tab name=‘NestedTabA2’ label=‘Nested Tab A-2’>
  (Insert a user JSP and/or HTML code
  for displaying a user console extension here.)
  </wl:tab>
</wl:tab>
  <wl:tab name=‘TopLevelTabB’ label=‘Top Level Tab B’>
  <wl:tab name=‘NestedTabB1’ label=‘Nested Tab B-1’>
  (Insert a user JSP and/or HTML code
  for displaying a user console extension here.)
  </wl:tab>
  <wl:tab name=‘NestedTabB2’ label=‘Nested Tab B-2’>
  (Insert a user JSP and/or HTML code
  for displaying a user console extension here.)
  </wl:tab>
</wl:tab>
```

A JSP tag library can be used to create console extensions in one embodiment. The tag library allows a user to:
Create new nodes in the Administration Console navigation tree.
Create right-select options for the nodes in the Administration Console navigation tree.
Create a tabbed interface for displaying a user console extension.
Localize (render text in an alternate language) the text displayed in the Navigation Tree and in a user console extension tree.

The <wl:node> tag can be used to create new nodes in the Administration Console navigation tree in one embodiment. The following example demonstrates the usage of the <wl:node> tag:

```
<wl:node
  label=‘<%=“My Console Extension”%>’
  icon=‘/images/smiley.gif’
expanded=‘true’>
<wl:node
  label=‘My 1st nested node’
    icon=‘/images/bullet.gif’
    url=‘/dialog_domain_example.jsp’>
  </wl:node>
  <wl:node label=‘My 2nd nested node’
    icon=‘/images/bullet.gif’>
  </wl:node>
</wl:node>
```

TABLE 1
Attributes of the <wl:node> Tag in an Embodiment

| ATTRIBUTE | DESCRIPTION |
|---|---|
| icon | The URL of an image file (.gif or .jpg) that is displayed in the |
| | navigation tree for this node. The URLmay be an absolute URL, (for |
| | example, http://somesite.com/images/myIcon.gif) or a URL |
| | relative to the Web Application containing the console extension (for |
| | example, /images/myIcon.gif.). |
| label | The text label displayed for this node. |
| labelId | The Catalog ID of the localized text label for this node. |
| url | The URL of the page that should be displayed in the Administration |
| | Console when the user selects this node. The URLmay be an absolute |
| | URL, (for example, http://somesite.com/myPage.jsp) or a URL |
| | relative to the Web Application containing the console extension. |
| target | The name of a browser frame where the URL specified in the url |
| | attribute should be displayed. If this attribute is not specified, the |
| | URL is displayed in the right pane of the Administration Console. A |
| | user may use any name a user choose or one of the following |
| | keywords: |
| | _top - Displays the URL in the same browser window that displays the |
| | console, replacing the console. |
| | _blank - Displays the page specified by the url attribute in a new |
| | browser window. |
| expanded | Set to true or false. If set to true, the node appears expanded (all child |
| | nodes are visible) when the console first loads. Default is false. |
| font | Font used to display the node's text label. Support for fonts is |
| | browser-dependent. |

In one embodiment, the <wl:menu> can be used to create menus and actions that users access by right-selecting on nodes in the navigation tree defined with the <wl:node> tag. The <wl:menu-separator> tab inserts a separator line in the right-select menu.

```
...
  <wl:node
    label=‘My 2nd nested node’
    icon=‘/images/bullet.gif’>
    <wl:menu
      label=‘BEA Product Documentation’
      url=‘http://e-docs.bea.com/index.html’
      target=‘_blank’/>
    <wl:menu-separator/>
    <wl:menu
    label=‘BEA home page’
    url=‘http://www.bea.com’
    target=‘_blank’/>
  </wl:node>
...
```

The above code creates a right-select menu under the “My 2nd Nested Node” entry in the navigation tree.

TABLE 2
Attributes of the <wl:menu> Tag in an Embodiment

| ATTRIBUTE | DESCRIPTION |
|---|---|
| Label | Text label that appears for this menu item. |
| LabelId | The Catalog ID of the localized text label for this |
| | menu item. |
| url | Absolute URL or a URL relative to theWebApplication |
| | root for a page to be displayed in the console. |
| Target | The name of a browser frame where the URL specified |
| | in the url attribute should be displayed. If this attribute is |
| | not specified, the URL is displayed in the right pane of |
| | the Administration Console. A user may use any name |
| | a user choose or one of the following keywords: |
| | _top - Displays the URL in the same browser window |
| | that displays the console, replacing the console. |
| | _blank - Displays the page specified by the url attribute |
| | in a new browser window. |

In one embodiment, the <wl:tab> tag can be used to create a tabbed interface in a user console extension. A user can create nested tabbed screens by nesting a <wl:tab> tag within another <wl:tab> tag. N levels of nesting are supported. The following example demonstrates the usage of the <wl:tab> tag:

```
<wl:tab name=‘TopLevelTabA’ label=‘Top Level Tab A’>
  <wl:tab name=‘NestedTabA1’ label=‘Nested Tab A-1’>
    (Insert a user JSP and/or HTML code
    for displaying a user console extension here.)
  </wl:tab>
  <wl:tab name=‘NestedTabA2’ label=‘Nested Tab A-2’>
  (Insert a user JSP and/or HTML code
  for displaying a user console extension here.)
  </wl:tab>
</wl:tab>
<wl:tab name=‘TopLevelTabB’ label=‘Top Level Tab B’>
  <wl:tab name=‘NestedTabB1’ label=‘Nested Tab B-1’>
    (Insert a user JSP and/or HTML code
    for displaying a user console extension here.)
  </wl:tab>
  <wl:tab name=‘NestedTabB2’ label=‘Nested Tab B-2’>
    (Insert a user JSP and/or HTML code
    for displaying a user console extension here.)
  </wl:tab>
</wl:tab>
```

TABLE 3
Attributes of the <wl:tab> Tag in an Embodiment

| ATTRIBUTE | DESCRIPTION |
|---|---|
| Name | The name of the tab. Do not use the period (.) character |
| | in the name. If a user do not specify the labelId attribute, |
| | the console looks for an entry in the localization catalog |
| | with the form tab + name. For example, if a user |
| | set name to config, the console labels the tab by looking |
| | up localized text located in the catalog using the ID |
| | tab.config. |
| Label | The exact text that appears as the title of the tab. |
| | Do not define this attribute if a user define the labelId |
| | attribute. Use this attribute only if a user are not using |
| | a localization catalog. |
| LabelId | The catalog ID for a localized label for the tab, |
| | if different from the name attribute. This text is looked |
| | up in the localization catalog. Do not define this attribute |
| | if a user define the label attribute. |

In one embodiment, the <wl:dialog> tag can be used to demarcate a section of a JSP that defines tabbed console screens. <wl:tab> tags appear with in a <wl:dialog> block.

```
...
<wl:dialog>
    <wl:tab>
        ....(Insert code for tabbed dialog screen here.)
    </wl:tab>
</wl:dialog>
...
```

In one embodiment, the <wl:stylesheet> tag can be used to specify that a user control panels use the same display styles (fonts, colors, etc.) as the standard Administration Console.

```
<html>
  <head>
    <wl:stylesheet/>
  </head>
  ...
```

In one embodiment, the <wl:extensibility-key> tag can be used to create a scripting variable that represents a Java object. A user can use this tag in the JSP that defines the Navigation tree.

```
<wl:extensibility-key
  id=‘domainKey’
  class=‘.management.configuration.DomainMBean’ />
<%=“Configuration Version is” +
domainKey.getConfigurationVersion( )%>
```

TABLE 4
Attributes of the <wl:text> Tag in an Embodiment

| ATTRIBUTE | DESCRIPTION |
|---|---|
| id | Name of the scripting variable. |
| class | Java class of the scripting variable. |

In one embodiment, the <wl:text> tag can be used to display text from the localization catalog. For example:

<wl:text textId=‘Text.3’ textParamId=‘Param.1’ />
<p>
<wl:text textId=‘Text.2’ textParam=“Blue”/>

TABLE 5
Attributes of the <wl:text> Tag

| Attribute | Description |
|---|---|
| Style | (Optional) HTML Style class used to display the text. |
| Text | The actual text a user want to display. |
| TextId | The catalog ID for the localized text a user want to display. |
| | This text is looked up in the localization catalog. |
| TextParamId | The localization catalog ID of text that is substituted for any |
| | occurrence of the string {0} in text retrieved from the |
| | catalog. |

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a storage medium (media) having instructions stored thereon/in which can be used to program a computer to perform any of the features presented herein. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and applications.

The foregoing description of the preferred embodiments of the present invention has been provided for the purposes of illustration and description. It is not intended to be exhaustive or to limit the invention to the precise forms disclosed. Many modifications and variations will be apparent to the practitioner skilled in the art. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

1. An extensible administration tool, comprising:
a first graphical user interface (GUI) operable to provide hierarchical navigation of a tree;
a second GUI operable to provide at least one control panel;
a framework for customizing the first and second GUIs; and
wherein the at least one control panel can be activated by selection of the node in the tree.

2. The tool of claim 1 wherein the framework comprises:
a first group of services related to extending the tree; and
a second group of services related to defining a control panel.

3. The tool of claim 2 wherein the first group of services includes:
first functions operable to add a node to the tree; and
wherein the node can be associated with an icon and/or a Uniform Resource Locator (URL).

4. The tool of claim 3 wherein:
the URL is the address of a control panel implementation.

5. The tool of claim 2 wherein the second group of services includes:
first functions operable to create a control panel.

6. The tool of claim 1 wherein:
the tree contains at least one node; and
wherein the at least one node can represent a network-accessible entity that can be administratively controlled by the tool.

7. The tool of claim 1 wherein:
the tree contains at least one node; and
wherein the at least one node is associated with at least one of: 1) a menu; 2) another node; and 3) a control panel.

8. The tool of claim 1 wherein:
the tree provides a graphical representation of network resources.

9. The tool of claim 1 wherein:
the tool can be used to administer resources within an application and/or web server.

10. The tool of claim 1 wherein:
the at least one control panel can include tabs.

11. An extensible administration tool, comprising:
a first graphical user interface (GUI) operable to provide hierarchical navigation of a tree;
a second GUI operable to provide at least one control panel;
a framework for customizing the first and second GUIs;
wherein the at least one control panel can be activated by selection of the node in the tree; and
wherein the tool can be used to administer resources within an application and/or web server.

12. The tool of claim 11 wherein the framework comprises:
a first group of services related to extending the tree; and
a second group of services related to defining a control panel.

13. The tool of claim 12 wherein the first group of services includes:
first functions operable to add a node to the tree; and
wherein the node can be associated with an icon and/or a Uniform Resource Locator (URL).

14. The tool of claim 13 wherein:
the URL is the address of a control panel implementation.

15. The tool of claim 12 wherein the second group of services includes:
first functions operable to create a control panel.

16. The tool of claim 11 wherein:
the tree contains at least one node; and
wherein the at least one node can represent a network-accessible entity that can be administratively controlled by the tool.

17. The tool of claim 11 wherein:
the tree contains at least one node; and
wherein the at least one node is associated with at least one of: 1) a menu; 2) another node; and 3) a control panel.

18. The tool of claim 11 wherein:
the tree provides a graphical representation of network resources.

19. The tool of claim 11 wherein:
the at least one control panel can include tabs.

20. A method for customizing an administration tool, said method comprising:
providing a control panel wherein the control panel is operable to configure a network-accessible resource;
adding a node to a graphical representation of a resource tree;
associating the node with the control panel; and
wherein the control panel can be activated by selection of the node in the resource tree.

21. The method of claim 20 wherein providing a control panel comprises: implementing a Java Server Page (JSP).

22. The method of claim 20 wherein adding a node to the resource tree comprises:
making the node a child of at least one other node.

23. The method of claim 20 wherein:
the tree contains at least one node; and
wherein the at least one node can represent a network-accessible entity that can be administratively controlled by the tool.

24. The method of claim 20 wherein:
the tree contains at least one node; and
wherein the at least one node is associated with at least one of: 1) a menu; 1) another node; and 3) a control panel.

25. The method of claim 20 wherein:
the tree provides a graphical representation of network resources.

26. The method of claim 20 wherein:
the tool can be used to administer resources within an application and/or a web server.

27. The method of claim 20 wherein:
the control panel can include tabs.

28. A method for customizing an administration tool, said method comprising:
providing a control panel wherein the control panel is operable to configure a network-accessible resource;
adding a node to a graphical representation of a resource tree;
associating the node with the control panel;
wherein the control panel can be activated by selection of the node in the resource tree; and
wherein the tool can be used to administer resources within an application and/or a web server.

29. The method of claim 28 wherein providing a control panel comprises:
implementing a Java Server Page (JSP).

30. The method of claim 28 wherein adding a node to the resource tree comprises:
making the node a child of at least one other node.

31. The method of claim 28 wherein:
the tree contains at least one node; and
wherein the at least one node can represent a network-accessible entity that can be administratively controlled by the tool.

32. The method of claim 28 wherein:
the tree contains at least one node; and
wherein the at least one node is associated with at least one of: 1) a menu; 1) another node; and 3) a control panel.

33. The method of claim 28 wherein:
the tree provides a graphical representation of network resources.

34. The method of claim 28 wherein:
the control panel can include tabs.

35. A machine readable medium having instructions stored thereon that when executed by a processor cause a system to:
provide a control panel wherein the control panel is operable to configure a network-accessible resource;
add a node to a graphical representation of a resource tree;
associate the node with the control panel;
wherein the control panel can be activated by selection of the node in the resource tree; and
wherein the tool can be used to administer resources within an application and/or a web server.

36. The machine readable medium of claim 35 wherein providing a control panel comprises instructions that when executed cause the system to:
implement a Java Server Page (JSP).

37. The machine readable medium of claim 35 wherein adding a node to the resource tree further comprising instructions that when executed cause the system to:
make the node a child of at least one other node.

38. The machine readable medium of claim 35 wherein:
the tree contains at least one node; and
wherein the at least one node can represent a network-accessible entity that can be administratively controlled by the tool.

39. The machine readable medium of claim 35 wherein:
the tree contains at least one node; and
wherein the at least one node is associated with at least one of: 1) a menu; 1) another node; and 3) a control panel.

40. The machine readable medium of claim 35 wherein:
the tree provides a graphical representation of network resources.

41. The machine readable medium of claim 35 wherein:
the control panel can include tabs.
